(19) United States
(12) Patent Application Publication
(10) Pub. No.: US 2005/0196557 A1
(43) Pub. Date: Sep. 8, 2005

(54) Inkjet recording sheet, manufacturing method of inkjet recording sheet, and inkjet recording method

(75) Inventor: Masayuki Ushiku, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Holdings, Inc.

(21) Appl. No.: 11/046,272

(22) Filed: Jan. 28, 2005

(30) Foreign Application Priority Data
Feb. 6, 2004 (JP) JP2004-030391

(51) Int. Cl. B41M 5/00

(52) U.S. Cl. 428/32.34

(57) ABSTRACT

A inkjet recording sheet comprising a support and provided thereon, a porous ink absorptive layer containing inorganic micro-particles and a hydrophilic binder, wherein the ink absorptive layer contains 0.15-2.5 g/m² of a surfactant having a dynamic surface tension of a 0.3% aqueous solution, which is measured by a maximum bubble pressure method, of not more than 60 mN/m at 20 m·sec under a condition of a liquid temperature of 35° C.

### FIELD OF THE INVENTION

The present invention relates to a new inkjet recording sheet, a manufacturing method thereof and an inkjet recording method.

### BACKGROUND OF THE INVENTION

In recent years, inkjet recording has been rapidly improving the image quality, which is approaching to photographic image quality, however, improvement of techniques for an inkjet recoding sheet is desired with respect to final print quality and image lasting stability.

An example of inkjet recording sheets to achieve such high image quality is an inkjet recording sheet provided with a swelling type ink absorptive layer comprising primarily a hydrophilic binder on a support, and such an inkjet recording sheet provides appearances similar to photography after recording. On the other hand, high speed recording of inkjet recording method is in progress so that a high ink absorbability and a rapid drying property are required, while an inkjet recording sheet provided with the swelling type ink absorptive layer described-above is slow in an ink absorption rate and liable to generate image defects, in which images show mottled appearance due to such as association of ink liquid drops each other, in the case of high speed recording. Further, there is a disadvantage of easy bleeding of ink in a formed image after printing, particularly in the case of being stored under high humidity.

To overcome a problem such as described above, there is known an inkjet recording sheet in which an ink absorptive rate and bleeding resistance have been improved by providing an ink absorptive layer comprising a porous layer constituted of primarily a small amount of a hydrophilic binder, a plenty amount of inorganic micro-particles, a cross-linking agent and a cationic dye fixing agent. Inorganic micro-particles utilized in this porous type inkjet recording sheet include those having a mean particle diameter of approximately 1 μm and those having a mean particle diameter of not more than 100 nm.

An inkjet recording sheet utilizing inorganic micro-particles of approximately 1 μm exhibits excellent ink absorbability, however, the smoothness of the ink absorptive layer surface is inferior and glossiness is low. While, in the case of utilizing inorganic micro-particles having a mean particle diameter of not more than 100 nm, obtained can be an inkjet recording sheet provided with high smoothness of an ink absorptive layer surface, high glossiness and appearances similar to photography in addition to an excellent ink absorbability.

As an example of such a porous type inkjet recording sheet, described is an example of a coating solution comprising silica as inorganic micro-particles, polyvinyl alcohol as a hydrophilic binder and boric acid or a salt thereof as a cross-linking agent, and said coating solution is provided with a viscosity increasing effect under lower temperatures (for example in JP-A Nos. 10-119423 and 2000-218927 (hereinafter, JP-A refers to Japanese Patent. Publication Open to Public Inspection)). By utilizing the characteristic of this coating solution, after a coating solution is coated on a support and subjected to viscosity increase by cooling, drying by blowing a strong wind of a relatively high temperature (approximately 20-60° C.) can be performed, and an excellent printing densities can be obtained due to the ink absorptive layer provided with a high porous volume.

On the other hand, in a porous type inkjet recording sheet provided with the above constitution, a printed image having a certain glossy feeling could be obtained, however, it was still insufficient in comparison to silver salt photography with respect to glossiness, and there was a problem of inducing bronzing. There is known a means to increase smoothness by such as a calendar treatment to obtain a higher glossiness, however, the formed porous structure is destroyed when a calendar treatment is applied so as to achieve sufficient glossiness, resulting in decrease of ink absorbability. Therefore, development of an improvement means is urgently required.

Further, in recent years, many attempts have been made to bring the image quality obtained by means of inkjet recording close to photography. Among them, the most important point for image quality improvement with respect to a printed dot is to make each one dot not visually distinguishable, therefore important is such as to make ejected ink liquid drop minute, or to use dye ink having a low density in combination to make distinguishing the dot difficult by decreasing the reflection density of a dot particularly in a high-light region.

Therefore, the quantity of ink, which is ejected and printed, tends to increase relatively so that ink absorptive capacity of an inkjet recording sheet becomes insufficient, resulting in actualizing a problem of such as deteriorated image quality and a poor drying property. However, when a porous type ink absorptive layer is made thick to increase the ink holding capacity as a remedy to the above problem, brittleness resistance of a coated layer may be deteriorated due to heavy thickness to easily generate such as cracks, or lowering of productivity may result due to an inevitable limitation of the coating speed in the case of drying the film with a constant drying capacity.

As another means to solve this problem, ink quantity required by a necessary dot size can be decreased by enlarging the dot diameter per an ink liquid drop, which is printed on an inkjet recording sheet. For example, when the dot enlargement ratio on an inkjet recording sheet is increased by 10%, ink quantity required for image formation can be decreased by 25% simultaneous with that the ink absorptive capacity of an inkjet recording sheet can be decreased, which is advantageous with respect to the print cost. Further, since the thickness of a porous type ink absorptive layer of an inkjet recording sheet can be reduced, there is a merit with respect to manufacturing such as depression of cracking and reduction of drying load, which are problems of a porous type inkjet recording sheet. However, it is a present state that no effective means has been found heretofore, with respect to a method to increase the dot enlargement ratio while keeping high ink absorbability.

### SUMMARY

This invention has been made in view of the above problems. The inkjet recording sheet, the manufacturing method thereof and inkjet recording method of this invention are characterized by a specific ink absorptive layer or a coating solution thereof.

### DESCRIPTION OF THE PREFERRED EMBODIMENT

This invention has been made in view of the above problems; the first objective is to provide a porous type inkjet recording sheet, which is characterized by increasing a dot enlargement ratio against an ink liquid drop, and an inkjet recording method utilizing the same; and the second objective is to provide a manufacturing method of a porous type inkjet recording sheet on which can be formed an image having high gloss and high quality even when said sheet has been coated at a high speed.

The above objectives of this invention can be achieved by the following constitutions.

(1) A porous type inkjet recording sheet provided with an ink absorptive layer, which contains at least inorganic micro-particles and a hydrophilic binder, on a support, wherein said ink absorptive layer contains 0.15-2.5 g/m² of a surfactant having a dynamic surface tension of a 0.3% aqueous solution, which is measured by a maximum bubble pressure method, of not more than 60 mN/m at 20 m·sec.

(2) The porous type inkjet recording sheet described in item (1), wherein the aforesaid inorganic micro-particles are silica by a gas phase method having a mean particle diameter of not more than 100 nm.

(3) A manufacturing method of a porous type inkjet recording sheet in which an ink absorptive layer coating solution, containing at least inorganic micro-particles and a hydrophilic binder on a support, is coated and dried, wherein said ink absorptive layer coating solution contains 0.15-2.5 g/m² of a surfactant having a dynamic surface tension of a 0.3% aqueous solution, which is measured by a maximum bubble pressure method, of not more than 60 mN/m at 20 m/sec.

(4) The manufacturing method of a porous type inkjet recording sheet described in item (3), wherein the aforesaid inorganic micro-particles are silica by a gas phase method having a mean particle diameter of not more than 100 nm.

(5) The inkjet recording sheet described in item (1) or (2), wherein viscosity A of an inkjet absorptive layer coating solution, which forms the aforesaid ink absorptive layer, at 40° C. is 10-300 mPa·s and viscosity B at 15° C. is not less than 40 times of said viscosity A.

(6) The porous type inkjet recording sheet described in item (1) or (2), wherein the modulus of elasticity of an ink absorptive layer coating solution to form the aforesaid ink absorptive layer measured by a ridged pendulum is increased by not less than 1.5 times with ionized radiation irradiation.

(7) The manufacturing method of a porous type inkjet recording sheet described in item (3) or (4), wherein viscosity A at 40° C. of the aforesaid ink absorptive layer coating solution is 10-300 mPa·s and viscosity B at 15° C. is not less than 40 times of said viscosity A.

(8) The manufacturing method of a porous type inkjet recording sheet described in item (3) or (4), wherein the modulus of elasticity measured by a ridged pendulum is increased by not less than 1.5 times with ionized radiation irradiation.

(9) An inkjet recording method, in which a porous type inkjet recording sheet containing a surfactant having a dynamic surface tension of a 0.3% aqueous solution, which is measured by a maximum bubble pressure method, of Tp (mN/m) at 20 m·sec and an inkjet ink having a dynamic surface tension of a 0.3% aqueous solution, which is measured by a maximum bubble pressure method, of Ti (mN/m) at 20 m·sec are utilized, wherein Ti/Tp>0.8 and Tp of said surfactant utilized in said porous type recording sheet is not more than 60 mN/m.

(10) The inkjet recording method described in item (9), wherein the aforesaid porous type inkjet recording sheet is manufactured by the manufacturing method described in item (1), (2), (5) or (6).

(11) The inkjet recording method described in item (9), wherein the aforesaid porous type inkjet recording sheet is manufactured by the manufacturing method described in item (3), (4), (7) or (8).

This invention can provide a porous type inkjet recording sheet, which is characterized by increasing the dot enlargement ratio against an ink liquid drop, as well as obtaining an image having high gloss and high image quality even when having been manufactured by a high speed coating, a manufacturing method thereof and an inkjet recording method.

In the following, the most preferable embodiment to perform this invention will be detailed.

As a result of extensive study in view of the above problems, the inventors have found that a porous type inkjet recording sheet, which exhibits an increased dot enlargement ratio of a landed ink liquid drop and provides a high quality image having high gloss and reduced generation of such as cracking defects even when being coated at a speed of coating and drying as high as not less than 100 m/min at the time of manufacturing, can be achieved by including 0.15-2.5 g/m² of a surfactant having a dynamic surface tension of a 0.3% aqueous solution, which is measured by a maximum bubble pressure method, of not more than 60 mN/m at 20 m·sec in an ink absorptive layer utilized for manufacturing of a porous type inkjet recording sheet, which contains inorganic micro-particles and a hydrophilic binder, and thereby achieved has been this invention.

Further, the inventors have found that a porous type inkjet recording sheet, which exhibits an increased dot enlargement ratio of a landed ink liquid drop and provides a high quality image having high gloss and reduced generation of such as cracking defects even when being coated at a high speed at the time of manufacturing, can be achieved by an inkjet recording method in which a porous type inkjet recording sheet including a surfactant having a dynamic surface tension of a 0.3% aqueous solution, which is measured by a maximum bubble pressure method, of Tp (mN/m) at 20 m·sec, and an inkjet ink including a surfactant having a dynamic surface tension of a 0.3% aqueous solution, which is measured by a maximum bubble pressure method, of Ti (mN/m) at 20 m·sec, are utilized and Ti/Tp>0.8 as well as Tp of said surfactant utilized in said porous type inkjet recording sheet is not more than 60 mN/m.

With respect to improvement of glossiness and of a dot enlargement ratio due to a surfactant provided with characteristics defined in this invention, it is estimated as follows although a clear interpretation is not yet reached.

As one of the factors to affect the film surface smoothness of a porous type inkjet recording sheet (hereinafter, also simply referred to as a recording sheet), it is considered that preferable is drying in a state of film surface having been leveled to be made smooth in a wet state immediately after having been coated. It is considered that a dynamic surface tension of an ink absorptive layer coating solution is decreased by addition of an appropriate amount of a surfactant according to this invention, and the leveling speed is increased resulting in improvement of the smoothness. Further, an ink absorptive layer coating solution is dried by blowing a strong wind after having been coated on a support and the viscosity of which has been increased by more than a specific condition, prevented can be such as setting mottle caused by air-impingement and a liquid inclination due to a drying wind, resulting in a high productivity owing to an increased drying rate. However, it has been proved according to the inventors' study that a desired glossiness is hardly obtained when an ink absorptive layer coating solution is dried at a high speed by employing a means to increase the viscosity at the time of coating to not less than 300 mPa·s. This phenomenon is considered to be caused because an ink absorptive layer coating solution is dried in a state of insufficient leveling when the viscosity of said coating solution is increased. It has been proved that high glossiness can be obtained by employing a constitution defined in this invention even when viscosity increase after coating is performed.

Further, it is considered as follows with respect to dot diameter enlargement of an ink liquid drop landed on a recording sheet. That is, a surfactant having a dynamic surface tension defined in this invention is provided with particularly high ability of decreasing a dynamic surface tension among ordinary surfactants. As a result, the surfactant is fast in its diffusion rate and surface orientation rate, and is provided with a characteristic of effectively lowering the surface tension of a newly generated gas-liquid interface. Therefore, the diffusion rate of a surfactant into ink at the time of landing is fast to increase the wet spreading rate of ink on a recording sheet, resulting in enlargement of a dot diameter.

Further, it has been proved that a dot enlargement ratio is improved, in particular, when a dynamic surface tension of a surfactant utilized in a recording sheet of this invention is near to and preferably not higher than that of a surfactant contained in ink.

In the following, this invention will be detailed.

First, a surfactant according to this invention will be explained.

In a recording sheet of this invention, it is preferable to achieve the effect of this invention provided that said recording sheet contains 0.15-2.5 g/m² of a surfactant having a dynamic surface tension of a 0.3% aqueous solution, which is measured by a maximum bubble pressure method, of not more than 60 mN/m at 20 m·sec, and the dynamic surface tension at 20 m·sec is not more than 55 mN/m.

The surfactants provided with characteristics defined in this invention are particularly those having high ability of decreasing a dynamic surface tension among surfactants commonly known.

Examples of a surfactant having high ability of decreasing a dynamic surface tension, according to this invention, include such as polyoxyethylene alkyl ether, polyoxyethylene alkylphenyl ether and alkyltrimethylammonium chloride, provided with an alkyl group having a carbon number of not more than 12, preferably an alkyl group having a carbon number of 7-9 and more preferably an alkyl group having a branched structure, with respect to providing higher ability of decreasing a dynamic surface tension. Further, there are surfactants having high ability of decreasing a dynamic surface tension, also among such as acetylene glycols, Pluronic type surfactants and sorbitan derivatives.

In this invention, an ionic property of surfactants is preferably either cationic or nonionic; in particular, many nonionic surfactants are provided with an ethylene oxide chain, and preferred are surfactants having an ethylene oxide number of not more than 10, preferably not more than 8 and more preferably having no ethylene oxide chain, with respect to obtaining an excellent porous layer which hardly generates cracking.

Herein, surfactants according to this invention is not limited to the surfactants described above, provided that they are characterized by being provided with a dynamic surface tension of a 0.3% aqueous solution, which is measured by a maximum bubble pressure method, of not more than 60 mN/m at 20 m·sec under a condition of a liquid temperature of 35° C.

The using amount of a surfactant utilized in this invention is necessarily in a range of 0.15-2.5 g/m² in an ink absorptive layer, and it is possible to make a high dot enlargement ratio and excellent ink absorbability compatible by setting the amount in this range.

When there is less amount of the surfactant used than 0.15, an effect does not show up easily. When the amount of the surfactant used exceeds 2.50, it is difficult to maintain ink rate of absorption required in order to attain acquiring forming the good image which spots do not produce, and sufficient drying capacity.

The cause that maintenance of ink rate of absorption is difficult is presumed that the porous in an ink absorbing layer are blocked by the surfactant, and the ratio of porous to the layer is decreased.

With respect to the addition method, there is obtained a dot enlargement effect similarly either by addition into an ink absorptive layer coating solution in advance or by over-coating a surfactant aqueous solution after coating and drying, however, it is possible to make high speed coating at not less than 80 m/min and high glossiness compatible by addition into an ink absorptive layer coating solution in advance and setting the addition amount in a range of 0.15-1.5 weight %.

Surfactants according to this invention are provided with a surface tension of a 0.3% aqueous solution, which is measured by a maximum bubble pressure method, of not more than 60 mN/m at 20 m·sec, and a maximum bubble pressure method referred in this invention is a means in which a bubble is formed in a solution and a surface tension is measured from a pressure applied on the bubble, and measurement of a dynamic surface tension of a liquid is possible by varying the bubble frequency. It is also called as a bubble pressure method.

Specifically, the interface between liquid and air is enlaerged by a nitrogen gas being blew out from a thin tube, which is inserted into the liquid, to swell a bubble, and a surface tension is determined from the maximum pressure at that time.

The increased portion of the surface area of a bubble ΔA is represented as below when a spherical bubble radius is increased from R to R+dR:
ΔA=4π(R+dR)²−4πR²=8πR·dR

While, a work performed by the pressure at this time is represented as follows since it moved a spherical surface having an area of 4πR² by dR.
W=ΔP·4πR²dRW=ΔP·4πR²dR

Therefore a surface tension γ is determined as follows.
γ=W/ΔA (a definition of a surface tension)=ΔP·R/2

Specific measurement apparatus according to a maximum bubble pressure method includes, for example, Dynamic Surface Tension Meter BP-D4 Type, manufactured by Kyowa Interface Science Co., Ltd.

Further, in a recording sheet of this invention, viscosity A at 40° C. of an ink absorptive layer coating solution to form an ink absorptive layer is preferably 10-300 mPa·s; and viscosity B at 15° C. is preferably not less than 40 times of viscosity A, more preferably 40-500 times and furthermore preferably 100-500 times.

By setting the viscosity variation ratio against temperature, as viscosity characteristics of an ink absorptive layer coating solution, into the conditions defined above, unevenness of the film surface and setting mottles or solution inclination caused by air-impingement due to rapid viscosity decrease can be effectively prevented, in particular, even when the layer is coated and dried at a high speed of not less than 100 m/min at the time of manufacturing, resulting in preparation of a porous type recording sheet which can provide a high quality image furthermore exhibiting high gloss and reduced generation of such as a cracking defect.

Further, as another method to control the coated layer viscosity after having been coated, it is preferable to make a modulus of elasticity measured by a rigid pendulum, which is a modulus of elasticity characteristic of an ink absorptive layer coating solution to form an ink absorptive layer, not less than 1.5 times of that before irradiation by ionized radiation irradiation.

A rigid pendulum referred in this invention is a meathod to measure viscoelasticity of a sample by observing a damping vibration of a pendulum which vibrates on a knife edge as a fulcrum while keeping contact with the sample. The variation ratio of a modulus of elasticity can be calculated from a vibration frequency and an amplitude damping ratio of the pendulum, and for example, measurement apparatuses such as Ridged Pendulum (RPT-3000W) manufactured by A & D Corp. and DDP-OPA manufactured by Orientic Corp. are available on the market.

As a modulus of elasticity measured by a ridged pendulum according to this invention, the modulus of elasticity before and after ionized radiation irradiation was measured by the aforesaid ridged pendulum with respect to a sample in which a coating solution to form an ink absorptive layer had been coated on a support described in the example described below at a wet thickness of 150 μm. At this time, ionized radiation was irradiated at an energy condition of 20 mJ/cm² by use of a metal halide lump having the primary wavelength of 365 nm. In this invention, a cracking defect is hardly generated and high glossiness is obtained even under a coating and drying condition of a coating speed of not less than 100 m/min, provided that the increase of the modulus of elasticity by ionized radiation irradiation is not less than 1.5 times, preferably 1.5-10.0 times and more preferably 3.0-10.0 times.

In a recording sheet of this invention, a method to achieve a viscosity variation ratio against the temperature of an ink absorptive layer coating solution, which is defined in this invention, is not specifically limited, and a desired condition can be set, in addition to a predetermined addition amount of a surfactant, for example, by a method which utilizes a significant viscosity increasing effect at low temperatures of the coating solution comprising a hydrophilic binder, polyvinyl alcohol and boric acid or a salt thereof as a cross-linking agent by use of silica, described in such as JP-A Nos. 10-119423 and 2000-218927 (hereinafter, JP-A refers to Japanese Patent Publication Open to Public Inspection), as inorganic micro-particles; by a method which utilizes a coating solution provided with a low temperature viscosity increasing characteristic by employing low temperature viscosity increasing particles constituted of a core portion comprising a copolymer containing methacrylic type monomer and a shell portion of a N-isopropylacrylamide, and by appropriately adjusting such as the type of a hydrophilic binder and the addition amount thereof, the type of a photopolymerization initiator and the addition amount thereof, and the type of inorganic micro-particles.

Further, a means to achieve the modulus of elasticity of an ink absorptive layer coating solution before and after ionized radiation irradiation, which is defined in this invention, is not specifically limited, however, it is preferable to utilize a photo-cross-linking type polymer compound in addition to a predetermined addition of a surfactant according to this invention; for example, applied by appropriate selection can be photo-cross-linking type polymer compounds described in such as JP-A Nos. 62-283339, 1-198615, 60-252341, 56-67309 and 60-129742.

Next, other constituent elements of a porous type inkjet recording sheet of this invention will be explained.

An ink absorptive layer of a porous type inkjet recording sheet of this invention contains at least inorganic micro-particles and a hydrophilic binder.

Inorganic micro-particles utilizable in this invention include, for example, white inorganic pigments such as light calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthesized amorphous silica, colloidal silica, alumina, colloidal alumina, pseudoboehmite, aluminum hydroxide, litopon, zeolite and magnesium hydroxide. The inorganic micro-particles described above may be utilized as primary particles as they are, or in a state of forming secondary condensed particles.

In this invention, to obtain a high quality print with a porous type inkjet recording sheet, silica type particles or alumina type particles provided with a low diffractive index and a mean particle diameter of approximately not more than 0.1 μm as inorganic particles are preferable with respect to availability at a relatively low cost, more preferable are alumina, pseudoboehmite, colloidal silica and micro-particle silica synthesized by a gas phase method are preferable, and specifically preferable is micro-particle silica synthesized by a gas phase method having a mean particle diameter of not more than 100 nm.

The silica synthesized by a gas phase method may be one the surface of which is modified by aluminum. The aluminum content of gas phase method silica, the surface of which is modified by aluminum, is preferably 0.05-5.0% based on a weight ratio against silica.

The particle diameter of inorganic micro-particles described above is preferably not more than 100 nm with respect to glossiness and color density. The under limit of the particle size is not specifically limited, however, in general preferably not more than 10 nm with respect to manufacturing.

The mean particle diameter of inorganic micro-particles described above can be determined by observing the cross-section or surface of a porous ink absorptive layer through an electronmicroscope to obtain particle diameters of arbitrary 100 particles, followed by calculating the simple average (number average). Herein, individual particle diameter is represented by a diameter of a supposed circle having an area equivalent to the projection area of the particle.

The above described inorganic micro-particles may present as primary particles as they are or as secondary or higher dimensionally aggregated particles in a porous layer, and the above-described mean particle diameter refers to that of independent particles in an ink absorptive layer when being observed through an electronmicroscope.

In the case that the above-described inorganic micro-particles are aggregated particles of a secondary or higher dimension, the mean primary particle diameter is smaller than the particle diameter observed in a porous layer and the primary particle diameter of inorganic micro-particles is preferably not more than 30 nm and more preferably 4-20 nm.

The content of the above-described inorganic micro-particles in an ink absorptive coating solution is 5-40 weight % and specifically preferably 7-30 weight %. The above-described inorganic micro-particles need to form an ink absorptive layer provided with sufficient ink absobability and minimum of such as layer cracks, and are preferably contained in the ink absorptive layer so as to make a coating amount of 5-50 g/m² and specifically preferably of 10-30 g/m².

A hydrophilic binder contained in an ink absorptive layer is not specifically limited, however, utilized can be conventionally well known hydrophilic binders such as gelatin, polyvinyl pyrrolidone, polyethylene oxide, polyacrylamide and polyvinyl alcohol, and specifically preferably polyvinyl alcohol with respect to a relatively small moisture absorbability of a binder, minimum curl of a recording sheet and a high binding capability for inorganic micro-particles, as well as excellent cracking resistance and layer adhesion with a small amount of addition.

Polyvinyl alcohols preferably utilized in this invention include modified polyvinyl alcohols such as those provided with a cationic modified end group or anionic modified polyvinyl alcohol provided with an anionic group, in addition to ordinary polyvinyl alcohol prepared by hydrolysis of polyvinyl acetate.

Polyvinyl alcohol prepared by hydrolysis of polyvinyl acetate is provided with a polymerization degree of preferably not less than 300 and specifically preferably 1,000-5,000, and a saponification degree of preferably 70-100% and specifically preferably 80-99.8%.

Cationic modified polyvinyl alcohol includes, for example, polyvinyl alcohol provided with a primary—tertiary amino group or a quaternary amino group in a main or side chain of the above described polyvinyl alcohol, described for example, in JP-A No. 61-10483, and these are prepared by hydrolysis of a copolymer of, an ethylenic unsaturated monomer having a cationic group, and vinyl acetate.

Ethylenic unsaturated monomers having a cationic group include, for example, trimethyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyl trimethylammonium chloride and trimethyl-(3-mehtacrylamidopropyl)ammonium chloride.

The ratio of a monomer containing a cationic modified group in cationic modified polyvinyl alcohol is 0.1-10.0 mol % and preferably 0.2-5.0 mol %, based on vinyl acetate.

Anionic modified polyvinyl alcohol includes, for example, polyvinyl alcohol provided with an anionic group described in JP-A No. 1-206088, a copolymer of vinyl alcohol and a vinyl compound having a water-soluble group described in JP-A Nos. 61-237681 and 63-307979, and modified polyvinyl alcohol having a water soluble group described in JP-A No. 7-286265.

Further, nonionic modified polyvinyl alcohol includes, for example, polyvinyl alcohol derivatives in which a polyalkylene oxide group is added to a part of polyvinyl alcohol, described in JP-A No. 7-9758, and block copolymers of a vinyl compound having a hydrophobic group and polyvinyl alcohol, described in JP-A No. 8-25795.

Polyvinyl alcohol can be utilized in combination of two or more types of such as different polymerization degrees and modification types. In particular, when polyvinyl alcohol having a polymerization degree of not less than 2,000 is utilized, it is preferable to add polyvinyl alcohol having a polymerization degree of not less than 2,000 after addition of 0.05-10 weight % and preferably 0.1-5.0 weight % based on inorganic micro-particles in advance, because significant viscosity increase is avoided.

The ratio of inorganic micro-particles against a hydrophilic binder in an ink absorptive layer is preferably 2-20 based on a weight ratio. When the weight ratio is not less than 2 times, a porous layer provided with a sufficient porous ratio can be obtained to assure a sufficient porous volume and not to induce the situation of clogging the porous due to swelling of a hydrophilic binder at the time of inkjet recording, which is a factor to maintain a high ink absorption rate. While, when the ratio is not more than 20 times, there barely causes cracking even in the case of coating a thick ink absorptive layer. A specifically preferable ratio of inorganic micro-particles against a hydrophilic binder is 2.5-12 times and most preferably 3-10 times.

Further, hydrophilic binders utilizable in an ink absorptive layer according to this invention include polymer compounds which can be cross-linkable by ionizing radiation.

Polymer compounds cross-linkable by ionizing radiation which are utilized in an ink absorptive layer of this invention are water-soluble hydrophilic binders which perform a cross-linking reaction caused by irradiation of ionizing radiation such as ultraviolet rays and electron rays, and become essentially water-insoluble after the cross-linking reaction although being water-soluble before cross-linking reaction.

Such resin is at least one type selected from a group comprising a saponification product of polyvinyl acetate, polyvinyl acetal, polyethylene oxide, polyvinyl pyrrolidone, polyacrylamide, hydroxyethyl cellulose, methyl cellulose, hydroxypropyl cellulose, or derivatives of the aforesaid hydrophilic binders, and copolymers thereof, or those in which said hydrophilic resins are modified by a modifying group of such as a photo-dimerizing type, a photo-decomposing type, a photo-polymerizing type, a photo-modification type and a photo-depolymerizing type.

As a specific cross-linking means by ionization radiation of a polymer compound, shown is a cross-linking means which utilizes polyvinyl alcohol, polyethylene oxide and hydroxypropyl cellulose as a polymer compound and electron rays as ionization radiation in JP-A No. 2002-160439. In the case of cross-linking hydrophilic resin by electron rays, since inorganic micro-particles have a specific gravity generally higher than a hydrophilic binder or water as a solvent, the irradiation quantity of electron rays is supplied excessively against the hydrophilic binder or the solvent, and water in a coated layer is evaporated in a moment to become a gas bubbles to roughen the coated layer surface or only the surface forms a hard coated layer resulting in a problem of significant damage on curl resistance due to insufficient irradiation quantity at the deep portion of the coated layer to generate a gradient of a cross-linking density. Further, at the time of electron rays irradiation, there is a problem of disturbing the irradiation effect when the environmental oxygen concentration is high, therefore, it is necessary that an irradiation zone has to be replaced by an inert gas such as nitrogen and helium to keep the oxygen concentration of approximately not more than 400 ppm, which is not preferable with respect to manufacturing adaptability. Further, in JP-A No. 9-263038, proposed, as a method to make a coated layer gelled prior to being dried, is a method in which a coating solution primary comprising an inorganic sol and an ionization radiation curable monomer/oligomer is subjected to a process to cure said compound by irradiation of ionization radiation after having been coated, followed by the coated layer being dried to form an ink absorptive layer; however, in this method, there caused a new problem of poor crease and crack resistance of the coated layer due to formation of a layer provided with relatively highly dense and minute three-dimensional cross-links. Further, generally, many of ionization radiation curable monomers/oligomers have a relatively small molecular weight and provided with strong skin stimulation, and there are many anxious points with respect to minus effects on print quality or safety aspects due to the unreacted components. Further, most of the compounds available on the market are not suitable for ordinary water-based coating in coating of an inkjet absorptive layer due to the low hydrophilic property, naturally resulting in an extremely narrow range of material selection.

In consideration of the above problems, polymer compounds, which are cross-linkable by ionization radiation, according to this invention are preferably polymer compounds provided with a plural number of side chains in the main chain and a polymerization degree of not less than 300, and said hydrophilic resins are specifically preferably modified with a modifying group of such as a photo-dimerizing type, a photo-decomposing type, a photo-polymerizing type, a photo-modification type and a photo-depolymerizing type. Among them, preferable are hydrophilic resins modified by a modification group of such as a photo-dimerization type and a photo-polymerizing type, with respect to obtaining binder characteristics of sensitivity, stability of resin itself as well as of minimum cracking generation.

Resin, in which introduced is a diazo group, a cinnamoyl group, a stilbazonium group or a styrylquinolinium group as a modifying group of a photo-dimerization type, is preferred, and resin which can be dyed with a water-soluble dye such as an anionic dye after photo-dimerization, is preferred. Such resin includes, for example, resin provided with such as primary to quaternary ammonium groups, for example, photosensitive resin (compositions) as described in JP-A Nos. 62-283339, 1-198615, 60-252341, 56-67309 and 60-129742; and resin provided with an azide group, which forms an amino group by a curing treatment, and become anionic after curing, for example, photosensitive resin (compositions) as described in JP-A No. 56-67309.

In this invention, hydrophilic resin which cross-links by ionization radiation is preferably a photo energy curing polyvinyl alcohol.

Specifically, for example, listed are the following compounds, however, this invention is not limited these compounds.

Photosensitive resin described in JP-A No. 56-67309 is a resin composition provided with a 2-azide-5-nitrophenylcarbonyl oxyethylene structure represented by the following general formula (I) 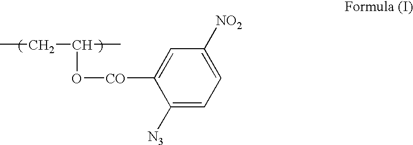
or a 4-azide-3-nitrophenylcarbonyl oxyethylene structure represented by the following general formula (II) in the polyvinyl alcohol structure.

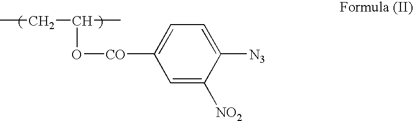

Specific examples of photosensitive resin is described in examples 1 and 2 of said patent publications, and the constituent components and the using amount are described in page 2 of said patent publication.

Further, in JP-A No. 60-129742, listed are resin compositions provided with the structures represented by following formulas (III) and (IV) in a polyvinyl alcohol structure as photosensitive resin.

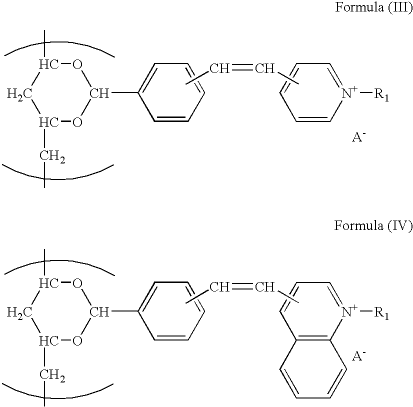

In this invention, among hydrophilic resin which is capable of cross-linking by ionization irradiation, the modifying groups of a photopolymerizing type, for example, are preferably saponification products of polyvinyl acetate provided with a constituent unit represented by following general formula (A), disclosed in JP-A No. 2000-181062, with respect to the reactivity.

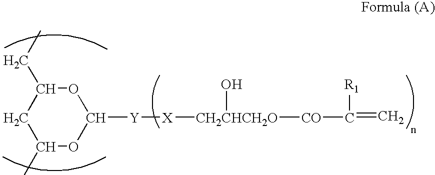

In above general formula (A), R₁ represents a hydrogen atom or a methyl group, Y represents an aromatic ring or a simple bonding hand, X represents —(CH₂)ₘ—COO—, —O—CH₂—COO— or —O—, m represents 0 or an integer of 1-6 and n represents 1 or 2.

In a hydrophilic resin according to this invention, such as a polymerization degree and a cross-link density affect the strength and flexibility at the time of film layer formation, and there caused defects such as a cracking at the time of coating and drying and a crease and break of the dried coated layer when the polymerization degree is too low or the cross-linking modifying group is excessive. Therefore, in a hydrophilic polymer compound containing a saponification product of polyvinyl acetate provided with a constituent unit represented by aforesaid general formula (A), the polymerization degree is preferably not less than 300, more preferably 400-5000 and most preferably 1000-4000. Further, the modification ratio of an ionization radiation reactive group against the segment is preferably not more than 4 mol % and more preferably 0.01-1.0 mol %.

Further, hydrophilic binders which are cross-linkable with ionization radiation according to this invention are easily available on the market, and include, for example, compounds referred as ultraviolet curable type monomers on the market, such as SR-230 (diethyleneglycol diacrylate), Karayadd PEG400DA, Karayadd R-167, PET-30, Satomer SR-230, Satomer SR-268, Satomer SR-344 and Satomer SR-444, manufactured by Nippon Kayaku Co., Ltd.; NK Ester A-200, NK Ester A-400, NK Ester A-600, NK Ester A-TMM-3 and NK Ester ATMM-3-L, manufactured by Shin-Nakamura Cemicals Co., Ltd.; Aronix M-240, Aronix M-245, Aronix M-205 and Aronix M-210, manufactured by To a Gosei Co., Ltd.

In this invention, the using amount of a hydrophilic binder containing a polymer compound polymerized by ionization radiation is preferably in a range of 1/3-1/15 and more preferably 1/3-1/7 as a weight ratio against inorganic micro-particles. Obtained can be an ink absorptive layer provided with a porous volume ratio of not less than 60% as well as hardly causing cracks, when the ratio is in this range.

In this invention, a photo-initiator and a sensitizer are preferably added together with a hydrophilic binder polymer containing a compound polymerized by ionization radiation. These compounds may be dissolved or dispersed in a solvent, or chemically bonded to the above-described hydrophilic binder containing a polymer compound.

Applied photo-initiators and photo-sensitizers are not specifically limited and photo-initiators and photo-sensitizers conventionally well known can be utilized, including, for example, benzophnones (such as benzophenone, hydroxylbenzophenone, bis-N,N-dimethylamino benzophenone and 4-methoxt-4′-dimethylaminobenzophenone), thioxantones (such as thioxantone, 2,4-diethylxanthone, isopropyl thioxantone, chloro thioxantone and isopropoxychloro thioxantone), anthraquinones (such as ethylanthraquinone, benzanthraquinone, aminoanthraquinone and chloroanthraquinone), acetophenones, benzoin ethers (such as benzoin methylether), 2,4,6-trihalomethyltriazines, 1-hydroxycyclohexyl phenyl ketone, a 2-(o-chlorophenyl)-4,5-diphenylimidazole dimer, a 2-(o-chlorophenyl)-4,5-di(m-methoxy phenyl)imidazole dimmer, a 2-(o-fluorophenyl)-4,5-diphenylimidazole dimer, a 2-(o-methoxyphenyl)-4,5-diphenylimidazole dimer, a 2-(p-methoxyphenyl)-4,5-diphenyl imidazole dimmer, a 2-(p-methoxyphenyl)-5-phenylimidazole dimer, a 2-(2,4-dimethoxyphenyl)-4,5-diphenylimidazole dimmer, a 2,4,5-triarylimidazole dimmer, benzyl dimethylketal, 2-benzyl-2-dimethylamino-1-(4-morpholinophenyl)-butane-1-one, 2-methyl-1-[4-(methylthio)phenyl]-2-morpholino-1-propane, 2-hydroxy-2-methyl-1-phenyl-propane-1-one, 1-[4-(2-hydroxyethoxy)-phenyl]-2-hydroxy-2-methyl-1-propane-1-one, phenanthrenequinone, benzoins such as 9,10-phenanthrenequinone, methybenzoin and ethylbendoin, acridine derivatives (such as 9-phenylacridine and 1,7-bis(9,9′-acridinyl)heptane), bisacylphosphine oxide and mixtures thereof, and the above described compounds may be utilized alone or in combinations of 2 or more types.

In particular, water-soluble initiators such as 1-[4-(2-hydroxyethoxy)-phenyl]-2-hydroxy-2-methyl-prpane-1-one, 4-(2-hydroxyethoxy)-phenyl-(2-hydroxy-2-propyl) ketone, a tioxantone ammonium salt and a benzophenone salt are preferable with respect to an excellent mixing property as well as the cross-linking efficiency.

In addition to these initiators, added may be such as an accelerator. Examples thereof include such as isoamyl p-dimethylaminobenzoate, ethanolamine, diethanolamine and triethanolamine.

Next, ionization radiations according to this invention will be explained. Ionization radiations include such as electron rays, ultraviolet rays, α rays, β rays, γ rays and X rays, however, preferable are electron rays or ultraviolet rays, which are industrially prevailing, with respect to safety for a human body and easy handling.

The irradiation method of electron rays includes, for example, a scanning mode, a curtain beam mode and a broad beam mode, and a curtain beam mode is preferable with respect to a processing capacity.

The acceleration voltage can be appropriately varied depending on the specific gravity and layer thickness of the coated layer, however, is suitably 20-300 kV. The irradiation quantity of electron rays is preferably in a range of 0.1-20 Mrad.

Further, to efficiently achieve objective effects of this invention, an irradiation light source is specifically preferably of ultraviolet rays. As a light source of ultraviolet rays, utilized are such as a low pressure, medium pressure and high pressure mercury lamps and a metal halide lamp, which are provided with an operating pressure of from a few hundreds Pa to one million Pa, however, a high pressure mercury lamp and a metal halide lamp are preferred with respect to the wavelength distribution of a light source, and a metal halide lamp is more preferable. Further, it is preferable to provide a filter to cut the light of wavelengths of not longer than 300 nm. The output power of a lamp is preferably 400W-30 kW, the illuminance is preferably 10 mW/cm²-10 kW/cm², and the irradiation energy is preferably 0.1-500 mJ/cm² and more preferably 1-100 mJ/cm².

The cases that ultraviolet rays having wavelengths of not longer than 300 nm are not contained in the wavelengths of a light source, the wavelengths of not longer than 300 nm is reduced by a filter, and the irradiation energy is not more than 500 mJ/cm², are preferable because avoided can be decomposition of the mother nucleus of ionization radiation cross-linkable resin or incorporated various types of additives by an ionization radiation, and very small is the possibility of causing such as a problem of odor due to decomposed products. Further, the effects of this invention are effectively achieved when the irradiation energy is not less than 0.1 mJ/cm².

The illuminance of ultraviolet irradiation is preferably 0.1 mW/cm²-1.0 W/cm². The surface curing property of a coated layer is improved so that the deep portion is cured to prepare a uniformly cross-linked layer when the illuminance is not more than 1 W/cm². In this case, the hardness along the depth direction is also uniform, and such as curling is hardly-generated, which is preferable. When the illuminance is not less than 10 mW/cm², unevenness of cross-linking is avoided due to such as scattering in a film, resulting in achievement of the effects of this invention.

In the case of providing the same cumulative quantity of light (mJ/cm²), a preferable illuminance range exists because the transmittance of the light changes. Since the concentration distribution of a generated cross-linking reaction species varies depending on the transmittance of ultraviolet rays, a high concentration of a cross-linking reaction species is generated in the surface layer to form a hard and close layer in the coated surface in the case of high illuminance of ultraviolet rays. In the case of preferable illuminance, since the cross-linking degree in the surface layer is low and the light transmittance toward the depth direction is high, mild cross-linking is uniformly formed toward the depth direction. When the illuminance is too low, it is not preferable because irradiation time to provide a required cumulative illuminance is long, which is disadvantageous with respect to such as introduction of installations, as well as the absolute quantity of rays is insufficient due to scattering of ultraviolet rays by the coated layer.

In an ink absorptive layer according to this invention, various types of additives in addition to inorganic micro-particles and a hydrophilic binder, which were explained above, can be utilized, and in particular, a cationic polymer, a cross-linking agent and a polyvalent metal compound play an important role with respect to improvement of ink absorbability and anti-bleeding of dye ink.

In an inkjet recording sheet of this invention, a cationic fixing agent such as a cationic polymer and a polyvalent metal compound may be utilized for the purpose of preventing bleeding of images during long term storage after image recording with dye ink, and these are preferably utilized also in this invention.

Examples of a cationic polymer include polyethyleneimine, polyallylamine, polyvinylamine, a dicyandiamido-polyalkylenepolyamine condensed compound, a polyalkylene polyamine dicyandiamide ammonium salt condensed compound, a dicyandiamido-formaline condensed compound, an epichlorohydrin-dialkylamine addition polymer, a diallyldimethylammonium chloride polymer compound, a diallyldimethylammonium chloride.SO₂ copolymer, polyvinylimidazole, a vinylpyrrolidone.vinylimidazole copolymer, polyvinylpyridine, polyamidine, chitosan, cationized starch, a vinylpyridyltrimethylammonium chloride polymer compound, a (2-methacryloyloxyethyl)trimethylammonium chloride polymer compound and a dimethylaminoethyl methacrylate polymer compound.

Further, listed as the examples are cationic polymers described in Bulletin of Chemical Industry, Aug. 15 and 25 (1998) and polymer dye adhesives described in “Introduction to Polymer Medicines” published by Sanyo Chemical Industry Co., Ltd.

On the other hand, polyvalent metal compounds (except zirconium oxide and aluminum oxide) include metal compounds of such as aluminum, calcium, magnesium, zinc, iron, strontium, barium, nickel, copper, scandium, gallium, indium, titanium, zirconium, tin and lead. Further, a polyvalent metal compound may be a polyvalent metal salt. Among them, compounds comprising magnesium, aluminum, zirconium, calcium and zinc are preferred because they are colorless.

In this invention, fixing agents specifically preferably utilized are compounds represented by following general formula (1), polyallylamine or derivatives thereof, or polyvalent metal salts described bellow.

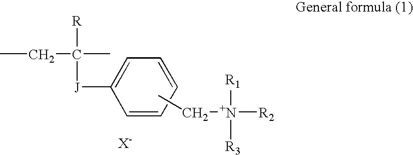

In general formula (1) described above, R represents a hydrogen atom or an alkyl group. R₁, R₂ and R₃ each represent an alkyl group or a benzyl group. J represents a simple bonding hand or a divalent organic group. X⁻ represents an anionic group.

In general formula (1) described above, an alkyl group represented by R is preferably a methyl group. An alkyl group represented by R1, R2 and R3 is preferably a methyl group, an ethyl group or a benzyl group. A divalent organic group represented by J is preferably —CON(R′)—. R′ represents a hydrogen atom or an alkyl group.

Anionic groups represented by X include, for example, a halogen ion, an acetic ion, a methyl sulfate ion and a p-toluene sufonate.

A preferable cationic polymer may be a homopolymer comprising a repeating unit represented by general formula (1) described above, or a copolymer thereof with another copolymerizable monomer. A copolymeraizable repeating unit includes a cationic monomer other than above general formula (1) and a monomer not provided with a cationic unit. Monomers provided with a cationic group includes, for example, the following repeating unit.

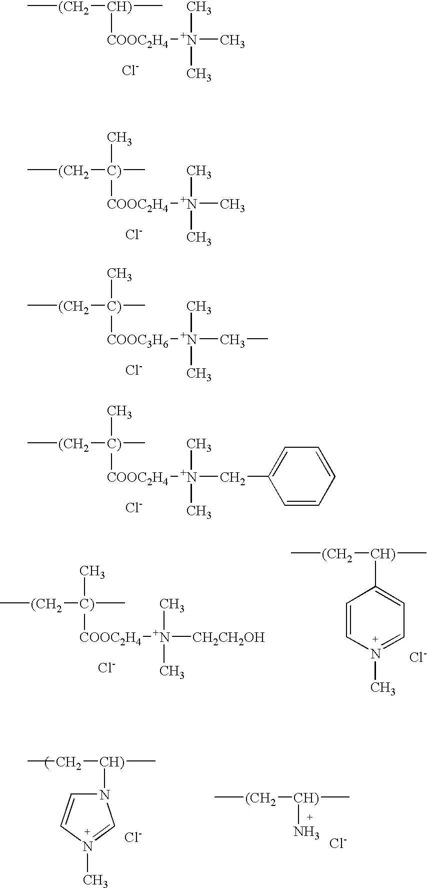

Copolymerizable repeating units not provided with a cationic group include, for example, ethylene, styrene, butadiene, methylmethacrylate, ethylmethacrylate, propylmethacrylate, butylmethacrylate, octylmethacrylate, methylacrylate, ethylacrylate, propylacrylate, butylacrylate, octylacrylate, hydroxylethylmethacrylate, acrylamide, vinyl acetate, vinylmethyl ether, vinyl chloride, 4-vinylpyridin, N-vinylpyrrolidone, N-vinylimidazole and acrylonitrile.

In the case that a cationic polymer preferably utilized in this invention is provided with a repeating unit represented by general formula (1) described above, the content of the repeating unit represented by general formula (1) described above is preferably not less than 20 mol % and specifically preferably 40-100 mol %.

In the following, shown are specific examples of cationic polymers provided with a repeating unit represented by general formula (1), according to this invention, however, this invention is not limited thereto.

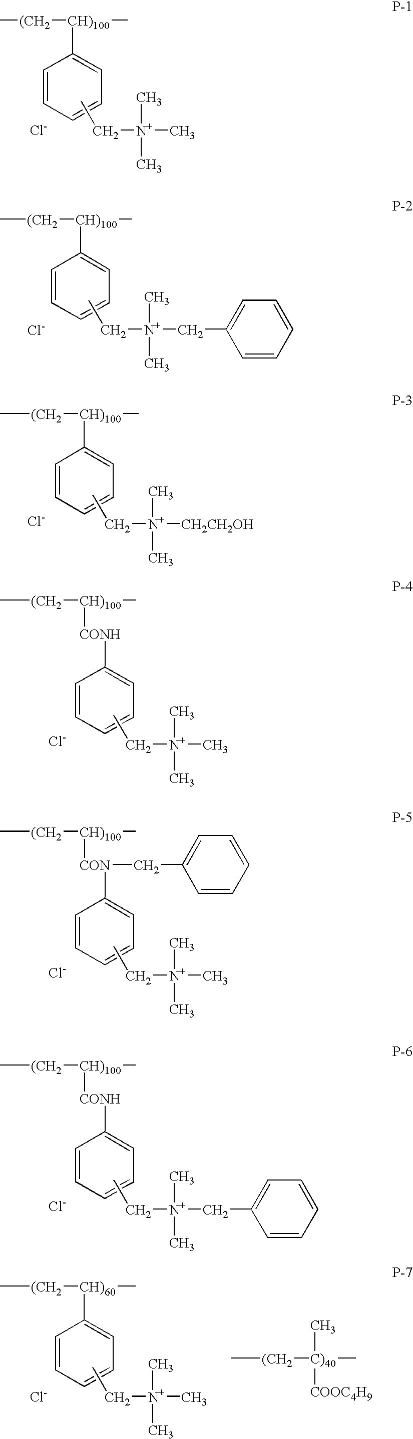

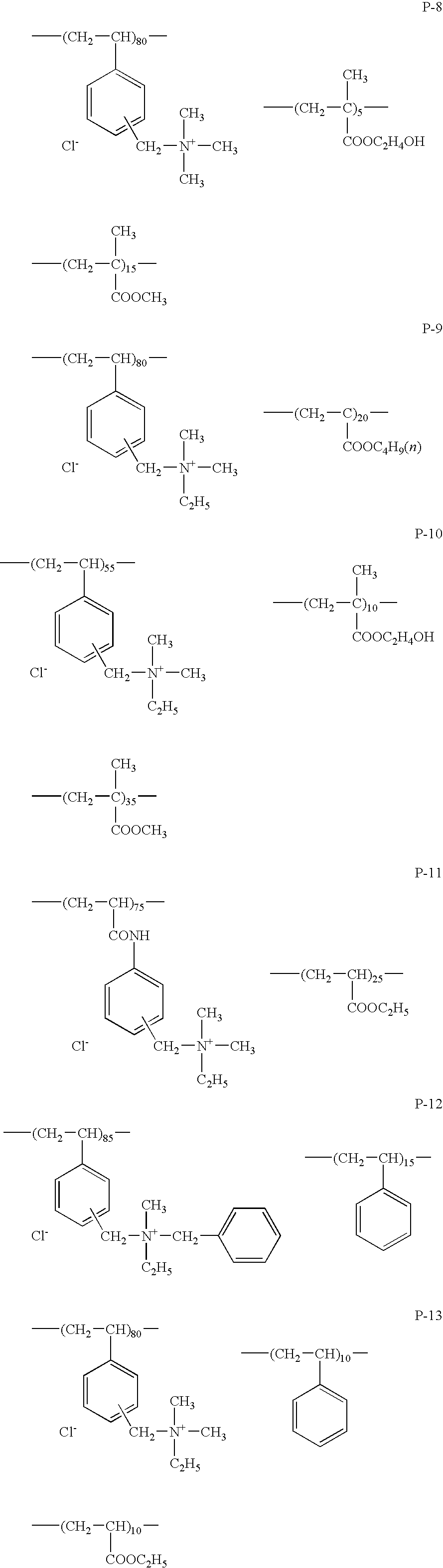

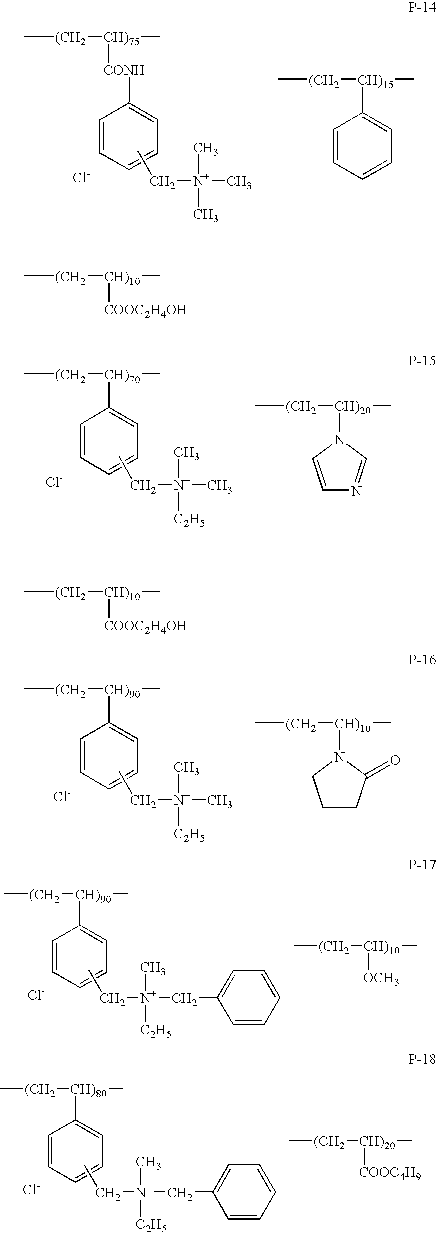

The weight average molecular weight of cationic polymers described above is approximately 3,000-200,000 and preferably 5,000-100,000. The weight average molecular weight is represented by a polyethylene converted value obtained by gel permeation chromatography.

A using amount of a cationic polymer according to this invention is approximately 0.1-10.0 g and preferably 0.2-5.0 g, per 1 m² of a recording sheet.

Next, polyallylamines according to this invention will be explained.

Polyallylamines referred in this invention are polyallylamine represented by following general formula (2), polydiallylamine represented by following general formula (3) or (4), polydiallylamine represented by following general formula (5) or (6), or polymer compound thereof.

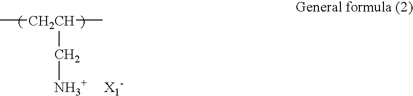

In general formula (2), X₁⁻ represents an inorganic or organic acid residual group.

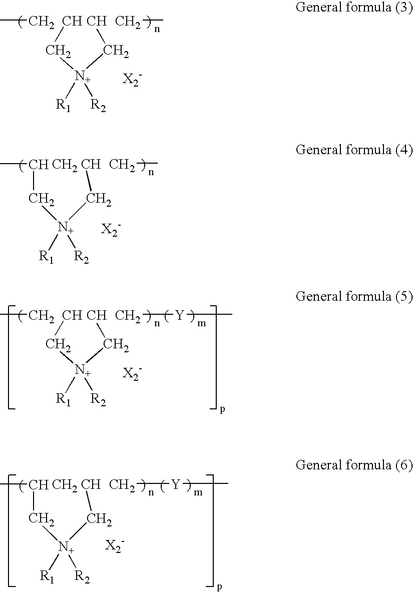

In general formulas (3), (4), (5) and (6), R₁ and R₂ each represent a hydrogen atom, a methyl group, an ethyl group or a hydroxyethyl group, X₂⁻ represents an inorganic acid residual group or an organic acid residual group, Y represents a divalent connecting group and n, m and p each represent a polymerization degree.

In general formulas (3) and (4), n is an integer of 5-10,000. Further, in general formulas (5) and (6), n/m=9/1-2/8 and p=5-10,000.

Specific examples of polydiallylamine derivatives represented by general formula (5) or (6) described above, include, for example, those provided with a repeating unit SO₂ represented by the general formula described in JP-A No. 60-83882, copolymers with acrylamide described at p. 2 of JP-A No. 1-9776 or copolymers with polydiallylamine represented by general formula (5) or (6), and these are available on the market as PAS series from Nitto Boseki Co., Ltd.

Preferable examples among these polyallylamines include polydiallylammoniums provided with a structure represented by general formula (7) or (8).

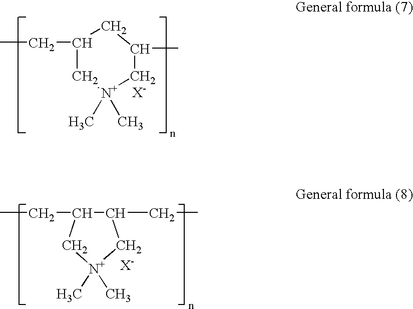

In general formulas (7) and (8) described above, n represents a polymerization degree. The polymerization degree is preferably not more than 1000 and more preferably not more than 800. When the polymerization degree is over 1000, the viscosity increases possibly resulting in handling difficulty. X represents an atom or an atomic group to be a monovalent anion, preferably a halogen atom and most preferably a chlorine atom.

As polydimethyldiallylammoniums, either one type of a compound provided with a structure represented by the above general formula (7) or a compound provided with a structure represented by the above general formula (8) may be utilized alone, or these compounds may be utilized in combination. In either case, those having different degrees of polymerization can be utilized by mixing. Further, polydimethyldiallylammoniums may be one appropriately synthesized, or those available on the market can be utilized.

Polyallylamines (including salts and modified compounds thereof) according to this invention is incorporated to improve a bleeding resistance, glossiness and printing density during image storage. Further, polyallylamines can specifically improve water resistance and bleeding resistance by interacting with liquid ink comprising an anionic dye as a colorant to stabilize the colorant.

The molecular weight of polyallylamines is preferably 3,000-30,000 and more preferably 5,000-20,000. When the weight average molecular weight is in the above range, it is possible to sufficiently improve water-resistance and bleeding resistance.

Salts of the aforesaid polyallylamines include inorganic acid salts such as a hydrochloride and a sulfate, and organic acid salts such as an acetate, a toluenesulfonate and a methanesulfonate.

The aforesaid modified compounds of polyallylamine are those in which 2-50 mmol % of such as acrylonitrile, chloromethylstyrene, TEMPO and epoxyhexane are added to polyallylamine, preferably a 5-10 mmol % adduct of acrylonitrile or chloromethylstyrene, and, in particular, a 5-10 mmol % acrylonitrile adduct of polyallylamine with respect to exhibiting a preventing effect against fading by ozone.

The content of polyallylamines is preferably 1-5 weight parts and more preferably 1.25-3.75 weight parts, based on 100 weight parts of inorganic micro-particles. The effects of this invention can be more efficiently exhibited by setting the content of polyallylamines in the above range.

Further, preferable polyvalent metal compounds are polyvalent metal inorganic polymers provided with a zirconium atom or an aluminum atom, among them, more preferable are a poly(aluminum chloride) compound, a poly(aluminum sulfate silicate) compound or a zirconium activated inorganic polymer, and most preferable are a poly(aluminum chloride) compound and a poly(aluminum sulfate silicate) compound.

Poly(aluminum chloride) compounds are represented by following general formulas (9), (10) and (11), poly(aluminum chloride) containing a multinuclear condensed ion (polymeric ion), which is basic and provided with a higher positive charge, as an effective component such as [Al₆(OH)₁₅]³⁺, [Al₈(OH)₂₀]⁴⁺ and [Al₁₃(OH)₃₄]⁵⁺.
[Al₂(OH)ₙCl₆₋ₙ]ₘ General formula (9)
[Al(OH)₃]ₙAlCl₃ General formula (10)
Alₙ(OH)ₘCl₍₃ₙ₋ₘ₎ General formula (11)

Poly(aluminum chloride) compounds available on the market include, for example, poly(aluminum hydroxide) (Paho) manufactured by Asada Chemicals Co., Ltd., poly(aluminum chloride) (PAC) manufactured by Taki Chemicals Co., Ltd. and Purachem WT manufactured by Riken Green Co., Ltd., and in addition to these, those of a variety of grades, which are on the market for the purpose of such as water processing agents from other manufacturers, can be available.

Products of a poly(aluminum silicate sulfate) compound on the market include PASS manufactured by Nippon Light Metal Co., Ltd.

Products of a zirconium oxychloride type inorganic polymer on the market include Zirucozole ZC-2 manufactured by Daiichi Rare Element Chemical Industrial Co., Ltd. and compounds described in Japanese Patent No. 2944143 can be also utilized.

The above-described compounds including a zirconium atom or an aluminum atom may be added into a coating solution to form an ink absorptive layer, which is coated and dried, or may be added by an over-coating method after an ink absorptive layer has been once coated and dried.

In the case of compounds containing a zirconium atom or an aluminum atom described above being added into a coating solution to form an ink absorptive layer, they can be added by being homogeneously dissolved in water, an organic solvent or a mixed solvent thereof, or by being dispersing into minute particles by such as a wet type grinding method by use of a sand mill and an emulsifying dispersion method. When an ink absorptive layer is constituted of a plural number of layers, it may be added in any coating solution, which forms one layer, two or more layers, or the all layers.

While, in the case of addition by an over-coating method after once forming a porous ink absorptive layer, it is preferable to be added by being dissolved in a homogeneous solution.

Compounds containing a zirconium atom or an aluminum atom are utilized generally in a range of 0.01-5.0 g, preferably 0.05-2.0 g and specifically preferably 0.1-1.0 g, per 1 m² of an inkjet recording sheet.

The above-described compounds may be utilized in combination of two or more types, and in this case, utilized can be, at least two types of compounds containing a zirconium atom, at least two types of compounds containing an aluminum atom, or a compound containing a zirconium atom and a compound containing an aluminum atom in combination.

An inkjet recording sheet of this invention is preferably added with a hardener for a water-soluble binder which forms a porous ink absorptive layer.

Hardeners utilizable in this invention are not specifically limited provided that they cause a curing reaction with a water soluble binder, however, preferably boric acid and salts thereof. In addition, those commonly known can be utilized other than these, and they are generally compounds provided with a group reactive with a water-soluble binder or compounds to accelerate a reaction between different groups of a water-soluble binder each other, which are utilized by suitable selection corresponding to the type of a water-soluble binder. Specific examples of the hardener include, for example, epoxy type hardeners (such as diglycidyl ethylether, ehtyleneglycol.diglycidylether, 1,4-butanediol diglycidylether, 1,6-diglycidylcyclohexane, N,N-diglycidyl-4-glycidyloxyaniline, sorbitol polyglycidylether and glycelol polyglycidylether), aldehyde type hardeners (such as formaldehyde and glyoxal), active, halogen type hardeners (such as 2,4-dichloro-4-hydroxy-1,3,5-s-triazine), active vinyl type hardeners (such as 1,3,5-trisacryloyl-hexahydro-s-triazine and bisvinylsulfonyl methylether) and aluminum alum.

Boric acids and salts thereof refer to oxyacids and salts thereof having a boron atom as the center atom, and specifically include orthoboric acid, diboric acid, methaboric acid, tetraboric acid, heptaboric acid and octaboric acid and salts thereof.

Boric acids and salts thereof having a boron atom as a hardener may be utilized as an aqueous solution of alone, or as a mixture of two or more types. Specifically preferable is a mixed aqueous solution of boric acid and borax. An aqueous solution of boric acid and borax enables to prepare a concentrated coating solution, because a concentrated aqueous solution can be formed by mixing boric acid and borax although each of them can be added only as a relatively diluted aqueous solution. Further, there is an advantage of relatively easy control of the pH of an adding aqueous solution. A total using amount of the above hardener is 1-600 mg per 1 g of the above water-soluble binder.

In a porous ink absorptive layer according to this invention, added can be various types of additives other than those described above. For example, incorporated can be commonly known various types of additives such as organic latex micro-particles of polystyrene, polyacrylic acid esters, polymethacrylic acid esters, polyacrylamides, polyethylene, polypropylne, polyvinyl chloride, polyvinilidene chloride, copolymers thereof, urea resin or melamine resin; various types of cationic or nonionic surfactants; UV absorbents described in JP-A Nos. 57-74193, 57-87988 and 62-261476; anti-fading agents described in JP-A Nos. 57-74192, 57-87989, 60-72785, 61-146591, 1-95091 and 3-13376; fluorescent whitening agents described in JP-A Nos. 59-42993, 59-52689, 62-280069, 61-242871 and 4-219266; pH controlling agents such as sulfuric acid, phosphoric acid, citric acid, sodium hydroxide, potassium hydroxide and potassium carbonate; defoaming agents, antiseptic agents, viscosity increasing agents, anti-static agents and matting agents.

A support utilized in this invention can be those well known as for conventional inkjet recording sheets. And it may be either a water absorptive support or a water non-absorptive support, however, preferably a water non-absorptive support.

Absorptive supports utilizable in this invention include, for example, such as a sheet and plate comprising ordinary paper, cloth and wood, however, paper is most preferable because the base material itself has excellent water absorbability and is superior with respect to cost. As a paper support, utilized can be those comprising wood pulp as a primary raw material such as chemical pulp like LBKP and NBKP, machine pulp like GP, CGP, RMP, TMP, CTMP, CMP and PGW, and used paper pulp like DIP. Further, appropriately various fiber form substances such as synthetic pulp, synthetic fiber and inorganic fiber can be suitably utilized as a raw material.

In the above support, appropriately added can be various types of additives which are conventionally well known such as a sizing agent, a pigment, a paper strength increasing agent, a fixing agent, a fluorescent whitening agent, a wet paper strength increasing agent and a cationizing agent.

A paper support can be manufactured by mixing a fiber form substance such as the aforesaid wood pulp with various types of additives and by use of various types of paper making machines such as a long net paper making machine, a circular net paper making machine and a twin wire paper making machine. Further, a size press treatment with such as starch or polyvinyl alcohol, various coating treatments or a calendar treatment is appropriately performed during or after a paper making stage.

As a support for an inkjet recording sheet of this invention, a water non-absorptive support is specifically preferable. A water non-absorptive support preferably utilized in this invention includes a transparent support or an opaque support. A transparent support includes films comprising a material such as polyester type resin, diacetate type resin, triacetate type resin, acryl type resin, polycarbonate type resin, polyvinyl chloride type resin, polyimide type resin, cellophane and celluloid, preferable among them are those provided with a property resistant against radiation heat when being utilized for OHP, and specifically preferable is polyethylene terephthalate. The thickness of such a transparent support is preferably 50-200 μm.

While, as an opaque support, preferable are, for example, resin coated paper (so-called RC paper) in which at least the one side of a base paper is provided with a polyolefin resin coat layer added with such as a white pigment, and so-called white PET comprising polyethylene terephthalate added with a white pigment such as barium sulfate.

To increase adhesion strength between the aforesaid various types of support and an ink absorptive layer, the support is preferably subjected to such as a corona discharge treatment or a sub-coat treatment in advance to being coated with an ink absorptive layer. Further, an inkjet recording sheet of this invention is not necessarily colorless but may be colored one.

In an inkjet recording sheet of this invention, a paper support comprising a raw paper support, the both surfaces of which are laminated with polyethylene, is specifically preferably utilized with respect to obtaining a recoded image having near photographic image quality as well as a high quality image at low cost. In the following, such a polyethylene laminated paper support will be explained.

Raw paper utilized for a paper support is primarily comprised of wood pulp, appropriately incorporated with synthetic pulp such as polypropylene or synthetic fiber such as nylon and polyester in addition to wood pulp, which is made into paper. As wood pulp utilized can be any of LBKP, LBSP, NBKP, NBSP, LDP, NDP, LUKP and NUKP, however, it is preferable to utilize more LBKP, NBSP, LBSP, NDP and LDP which are rich in a short fiber component. Herein, a ratio of LBSP and/or LDP is preferably 10-70 weight %.

As pulp described above, chemical pulp containing minimum impurities (such as sulfate pulp and sulfite pulp) is preferably utilized and pulp, whiteness of which is improved by a bleach treatment, is also useful.

In raw paper, suitably added can be a sizing agent such as a higher fatty acid and an alkylketene dimmer; whitening agents such as calcium carbonate, talc and titanium oxide; paper strength increasing agents such as starch, polyacrylamide and polyvinyl alcohol; fluorescent whitening agents; moisture retaining agents such as polyethylene glycol; dispersants; and softening agents such as quaternary ammonium.

The drainage of pulp utilized in paper making is preferably 200-500 ml based on the definition of CSF, and a fiber length after beating is preferably 30-70% as the sum of weight % of a 24 mesh residue and weight % of a 42 mesh residue based on the definition of JIS-P-8207. Herein, weight % of a 4 mesh residue is preferably not more than 20 weight %.

A basis weight of paper is preferably 30-250 g and specifically preferably 50-200 g. A thickness of raw paper is preferably 40-250 μm.

Raw paper may be subjected to a calendar treatment during or after the paper making, to be provided with a high smoothness. A density of raw paper is generally 0.7-1.2 g/m² (JIS-P-8118). Further, a stiffness of raw paper is preferably 20-200 g based on the conditions defined in JIS-P-8143.

A surface sizing agent may be coated on the surface of raw paper, and surface sizing agents, similar to those can be added in the aforesaid raw paper, can be utilized.

A pH of raw paper is preferably 5-9 when being measured according to a hot water extraction method defined in JIS-P-8113.

Polyethylene coated on the front and back surfaces of raw paper is primarily law density polyethylene (LDPE) and/or high density polyethylene (HDPE); however, others such as LLDPE and polypropylene can be also partly utilized.

Particularly, a polyethylene layer of an ink absorptive layer side is preferably one opacity and whiteness of which have been improved by addition of titanium oxide of a rutile or anatase type therein, as commonly applied in photographic print paper. The content of titanium oxide is generally 3-20 weight % and preferably 4-13 weight % based on polyethylene.

Polyethylene laminated paper can be utilized as glossy paper, and also utilized in this invention can be paper provided with a matt surface or a silk surface, similar to those prepared in ordinary photographic print paper, by a so-called embossing treatment when polyethylene is fusing extruded to be coated on the raw paper surface.

The water content of paper in the above polyethylene laminated paper is specifically preferably maintained at 3-10 weight %.

In an inkjet recording sheet of this invention, added can be various types of additives other than those described above. For example, incorporated can be commonly known various types of additives such as organic latex micro-particles of polystyrene, polyacrylic acid esters, polymethacrylic acid esters, polyacrylamides, polyethylene, polypropylene, polyvinyl chloride, polyvinilidene chloride, copolymers thereof, or melamine resin; various types of cationic or nonionic surfactants; UV absorbents described in JP-A Nos. 57-74193, 57-87988 and 62-261476; anti-fading agents described in JP-A Nos. 57-74192, 57-87989, 60-72785, 61-146591, 1-95091 and 3-13376; fluorescent whitening agents described in JP-A Nos. 59-42993, 59-52689, 62-280069, 61-242871 and 4-219266; pH controlling agents such as sulfuric acid, phosphoric acid, citric acid, sodium hydroxide, potassium hydroxide and potassium carbonate; defoaming agents, antiseptic agents, viscosity increasing agents, anti-static agents and matting agents.

Next, a manufacturing method of an inkjet recording sheet of this invention will be explained.

An inkjet recording sheet of this invention can be manufactured by coating each constituent layer including an ink absorptive layer on a support, each independently or simultaneously by means of a suitably selected commonly known coating method, followed by drying. As a coating method, preferably utilized are, for example, a roll coating method, a rod-bar coating method, an air-knife coating method, a spray coating method, a curtain coating method, as well as a slide bead coating method which employs a hopper described in U.S. Pat. Nos. 2,761,419 and 2,761,791, and an extrusion coating method.

Next, inkjet ink utilized in an inkjet recording method of this invention will be explained.

In an inkjet recording method of this invention, a porous type inkjet recording sheet containing a dynamic surface tension of a 0.3% aqueous solution, which is measured by a maximum bubble pressure method, of Tp (mN/m) at 20 m·sec and inkjet ink containing a dynamic surface tension of a 0.3% aqueous solution, which is measured by a maximum bubble pressure method, of Ti (mN/m) at 20 m·sec are utilized, wherein Ti/Tp>0.8 and Tp of said surfactant utilized in said porous type inkjet recording sheet is not more than 60 mN/m.

By printing by use of inkjet ink containing a dynamic surface tension of a 0.3% aqueous solution, which satisfies Ti/Tp>0.8 and is measured by a maximum bubble pressure method, of Ti (mN/m) at 20 m·sec, on a porous type inkjet recording sheet containing a dynamic surface tension of a 0.3% aqueous solution, which is measured by a maximum bubble pressure method, of not more than 60 (mN/m) at 20 m·sec, the diffusion rate of a surfactant into ink at the time of landing of ink is increased, resulting in a wet spreading rate on a recording sheet is increased to contribute to enlarge the dot diameter.

In an inkjet decording method of this invention, it is characterized by Ti/Tp>0.8, preferably 3.5>Ti/Tp>0.8 and more preferably 2.5>Ti/Tp>1.0.

As inkjet ink according to this invention, water-based ink is preferably utilized.

A water based ink referred to in this invention is a recording liquid provided with a colorant, solvent and other additives in addition to surfactant having the characteristics according to this invention.

As a colorant, utilized can be dyes and pigments well known in inkjet application, and typically utilized as dyes are such as acid dyes, direct dyes or basic dyes in which conventionally known azo dyes, xantene dyes, phthalocyanine type dyes, quinoline type dyes and anthraquinone type dyes which are improved in water solubility by introducing a sulfo group or a carboxylic.

On the other hand, as pigments utilized in pigment ink, applied can be various types of inorganic or organic pigment ink conventionally well known in inkjet application. Inorganic ink includes, for example, carbon black, titanium oxide and iron oxide. Further, organic pigments include various types of azo type pigments, phthalocyanine type pigments, anthraquinone type pigments, quinacridone type pigments, indigo type pigments or lake pigments which can be prepared by reacting a water-soluble dye and a polyvalent metal ion.

These pigment particles are preferably utilized together with various types of dispersants or dispersion stabilizers such as hydrophilic polymers and surfactants. The pigment particles are preferably utilized by being dispersed to a mean particle diameter of approximately 70-150 μm by use of these dispersants or dispersion stabilizers.

The concentration of a dye and a pigment in ink as a colorant described above depends on a type of a dye or pigment, a using form of ink (whether deep and light ink is utilized or not), and a type of a recording sheet, however, is generally 0.2-10.0 weight %.

Various types of solvents are utilized in colorant-containing ink, and as such solvents, water or organic solvents provided with a high compatibility with water can be utilized alone or by mixing with water. For example, preferable are alcohols such as methyl alcohol, isopropyl alcohol, butyl alcohol, tert-butyl alcohol, isobutyl alcohol; amides such as dimethylformamide and dimethylacetoamide; ketones and ketone alcohols such as acetone and diacetone alcohol; ethers such as tetrahydrofuran and dioxane; polyalkylene glycols such as polyethylene glycol and polypropylene glycol; polyhydric alcohols such as ethylene glycol, propylene glycol, butylenes glycol, triethylene glycol, 1,2,6-hexanetriol, thiodiglycol, hexylane glycol, diethylene glycol, glycerin and triethanolamine; lower alkyl ethers of polyhydric alcohols such as ethylene glycol methylether, diethylene glycol methyl(or ethyl)ether and triethylene glycol monobutylether. Among them, preferable are polyhydric alcohols such as diethylene glycol, triethanolamine and glycerin; and lower alkyl ethers of polyhydric alcohol such as triethylene glycol monobutylether.

To improve wettability against a recording sheet, a water-based ink is preferably provided with a static surface tension of generally in a range of 25-60 mN/m and preferably in a range of 30-50 mN/m. In ink according to this invention, a surfactant is preferably added to control the surface tension.

As surfactants, for example, those of an anionic type, an amphoteric type and a nonionic type in addition to surfactants according to this invention can be utilized, and typically, anionic type surfactants include a fatty acid salt, an alkyl sulfate, alkyl sulfate ester, alkylbenzene sulfonate, alkylnaphthalene sulfonate, dialkyl sulfosuccinate, alkyl phosphate ester, an alkylnaphthalene sulfonate formalin condenced compound, a polyoxyethylene alkylsulfate salt; cationic type surfactants include such as an amine salt, a tetraalkyl quarternary ammonium salt, a trialkyl quarternary ammonium salt, an alkylpyridinium salt and an alkylquinolinium salt; and nonionic type surfactants include such as polyoxyethylene alkylether, a polyoxyethylene propylene block polymer, polyoxyethylene alkylphenyether, polyoxyethylene fatty acid ester, polyoxyethylene sorbitane fatty acid ester, polyoxyethylene alkylamine and an ethyleneoxide adduct of acetylene alcohol.

The addition amount of these surfactant is determined depending on a type of a utilized water-soluble dye, a water-soluble organic solvent contained in ink, and a type and an amount of other additives, and is approximately in a range of 0.01-2.0 weight % and preferably a range of 0.05-1.0 weight %, based on the total ink weight.

Other additives of water-based ink include, for example, a pH controlling agent, a metal sealing agent, a fungicide, a viscosity adjusting agent, a surface tension adjusting agent, a wetting agent and an anti-corrosive.

The pH of the above-described ink is preferably 5-10 and specifically preferably 6-9.

### EXAMPLE

In the following, this invention will be specifically explained referring to examples, however, this invention is not limited thereto.

### Example 1

<Preparation of Recording Sheet 1-1>

[Preparation of Silica Dispersion A-1]

After 10 kg of silica by a gas phase method (product name: Aerosil 300, manufactured by Nippon Aerosil Co., Ltd., a mean primary particle diameter of 7 nm) was suction dispersed in a solution comprising 35 L of pure water added with 435 ml of ethanol at room temperature by use of Jet Stream Inductor Mixer manufactured by Mitamura Rilen Kogyo Co., Ltd., the total volume was made up to 43.5 L with pure water, resulting in a preparation of silica dispersion A-1. This silica dispersion has a pH of 2.8 and contains 1 weight % of ethanol.

[Preparation of Silica Dispersion P-1]

Above-prepared silica dispersion A-1 of 500 ml was added with 86 ml of an aqueous solution in which 50 ml of a 28% aqueous solution of a cationic dye fixing agent (example compound P-1), 2.6 g of boric acid and 1.8 g of borax were dissolved, and the resulting solution was pre-dispersed by use of Dissolver. Next, the dispersion was subjected to dispersion by a sand mill under a condition of a circumferential speed of 9 m/sec for 30 minutes. The total volume of this dispersion was made up to 638 ml with pure water to prepare almost transparent silica dispersion P-1. Obtained silica dispersion P-1 was filtered through a filter of TCP-10 type manufactured by Advantex Toyo Co., Ltd. Herein, with respect to obtained silica dispersion P-1, the mean particle diameter of silica micro-particles, measured by a laser scattering method (Zetasizer 1000, manufactured by Malvan Corp.) was 37 nm.

[Preparation of Ink Absorptive Layer Coating Solution]

Above-prepared silica dispersion P-1 of 556 ml was added with 220 ml of a 8% aqueous solution of polyvinyl alcohol (product name: PVA 235, manufactured by Kuraray Corp.) while being stirred at 40° C., and the total volume was made up to 1000 ml with pure water, resulting in preparation of a translucent ink absorptive layer coating solution.

[Preparation of Recording Sheet]

The ink absorptive layer coating solution prepared above was coated on a polyethylene coated paper, comprising raw paper, having a basis weight of 170 g/m², the both surfaces of which were coated with polyethylene (polyethylene of the ink absorptive layer coating side contained 8% of anatase type titanium oxide, and the ink absorptive layer coating side was provided with 0.05 g/m² of a gelatin under-coat layer, and the surface opposite to the ink absorptive layer side was provided with 0.2 g/m² of a back layer containing a latex polymer having a Tg of approximately 80° C.), by use of a curtain coater at a wet layer thickness of 150 μm and a coating speed of 15 m/min. After coating, it was dried with a cool wind of 5° C. followed by being stored under an environment of 40° C. and a relative humidity of 50% for 24 hours, resulting in preparation of recording sheet 1-1.

<Preparation of Recording Sheets 1-2-1-14>

Each of surfactant aqueous solutions S-1-S-7 described in table 2 was prepared, and each surfactant aqueous solution was over-coated on an ink absorptive layer of recording sheet 1-1 prepared above by use of a bar coater so as to make the coating amount described in table 2, resulting in preparation of recording sheets 1-2-1-14.

Recording sheets 1-1-1-14 prepared above exhibited high glossiness and the 60 degree glossiness measured by use of a variation degree gloss meter (VGS-1001DP), manufactured by Nippon Denshoku Kogyo Co., Ltd. was in a range of 42-44%.

Herein, the details of each surfactant utilized in preparation of above-described recording sheets 1-2-1-14 are shown in following table 1. The measurement of a dynamic surface tension of each surfactant described in table 1 was performed by preparing a 0.3% aqueous solution of each surfactant and continuously generating bubbles under a condition of a liquid temperature of 35° C. by use of BP2 manufactureed by Curus Corp. to determine a dynamic surface tension at 20 m·sec by a maximum bubble pressure method.

TABLE 1

| | | | Dynamic |
|---|---|---|---|
| | | | surface |
| | | | tension |
| Surfactant | | Composition | (mp/m) |
| S-1 | OLFIN E1010 | ethyleneoxide(EO) adduct of | 38.5 |
| | | acetylene glycol (EO: 10 mol) | |
| S-2 | NEWPOL PE64 | ethyleneoxide propyleneoxide | 44.9 |
| | | block polymer | |
| S-3 | QUARTAMIN | lauryltrimethylammonium chloride | 46.5 |
| | 24P | | |
| S-4 | SURFYNOL 82 | acetylene glycol | 53.4 |
| S-5 | PYONIN D941 | sorbitan derivatives | 57.8 |
| S-6 | OLFIN Y | acetylene glycol | 62.7 |
| S-7 | MEGAFACE | fuluorine compound | 69.9 |
| | F142D | | |
| S-8 | EMULGEN 910 | alkylphenyl ether | 55.0 |
| S-9 | SURFYNOL 440 | ethyleneoxide(EO) adduct of | 31.0 |
| | | acetylene glycol (EO: 4 mol) | |

OLFIN E1010, OLFIN Y, SURFYNOL 82 and SURFYNOL 440 were manufactured by NISSIN CHEMICAL INDUSTRY CO., LTD.
NEWPOL PE64 were manufactured by SANYO CHEMICAL INDUSTRIES, LTD.
QUARTAMIN 24P and EMULGEN 910 were manufactured by KAO CORPORATION.
PYONIN D941 was manufactured by TAKEMOTO YUSHI CORPORATION.
MEGAFACE F142D was manufactured by DAINIPPON INK AND CHEMICALS. INC.

<Evaluation of Recording Sheet>

The following each evaluation was performed with respect to the above-prepared each recording sheet.

[Evaluation of Ink Absorbability]

On each recording sheet, a green solid image was printed by use of Inkjet Printer PM-800C manufactured by Epson Corp., and the image disturbance was visually observed after the solid image portion having been rubbed With a finger. The ink absorbability was evaluated according to the following criteria.

A: No image disturbance is observed at all even when the image is rubbed with a finger.

B: Slight image disturbance is observed when the image is rubbed with a finger; however, the quality is not a problem in practical use.

C: Some image disturbance and dirt are observed when the image is rubbed with a finger, however, which is allowable in practical use.

D: Significant image disturbance and dirt are observed when the image is rubbed with a finger, and the quality is out of an allowable range.

[Evaluation of Dot Enlargement Ratio]

(Preparation of Ink Liquid 1)

Ink liquid 1 as black ink comprising the following composition was prepared.

| | | |
|---|---|---|
| C. I. Direct Yellow 86 | 3 | weight parts |
| C. I. Reactive Red 180 | 2.6 | weight parts |
| C. I. Direct Blue 199 | 2.5 | weight parts |
| Ethylene glycol | 24 | weight parts |
| Propylene glycol | 12 | weight parts |
| 2-Methyl-2,4-pentanediol | 10 | weight parts |
| S-8 (surfactant described | 0.05 | weight parts |
| in table 1) | | |
| Proxcel GXL (manufactured | 0.1 | weight part |
| by Abisia Corp) | | |
| Ion-exchanged water | 45.75 | weight parts |

(Inkjet Image Recording)

Inkjet head utilizing a piezo-ceramics described in JP-A No. 11-99644, image recording was performed with ink liquid 1 prepared above on each recording sheet under an ejection condition of a driving frequency of 30 kHz, a liquid drop quantity of 7 μl and a recording density of 70 dpi (dpi represents a dot number per 2.54 cm).

(Measurement of Dot Enlargement Ratio)

Dots in the obtained recording image were macro-photographed by use of a microscope equipped with a CCD camera inside, and a mean-value was determined by measuring dot diameters of 30 dots. The dot diameter of recording sheet 1-1 measured by this method is designated as 1.0, and the ratio of the dot diameter on each recording sheet thereto was obtained, which is a measure of dot enlargement ratio.

Each evaluation result obtained above is shown in table 2.

TABLE 2

| | Surfactant | | Result | | |
|---|---|---|---|---|---|
| | | Addition | | Dot | |
| Recording | | amount | Ink | Enlargement | |
| sheet No. | | (g/m²) | Absorbability | Ratio | Remark |
| 1-1 | — | — | A | 1.00 | Comp. |
| 1-2 | S-1 | 0.45 | A | 1.18 | Inv. |
| 1-3 | S-2 | 0.45 | A | 1.17 | Inv. |
| 1-4 | S-3 | 0.45 | A | 1.17 | Inv. |
| 1-5 | S-4 | 0.45 | A | 1.15 | Inv. |
| 1-6 | S-5 | 0.45 | A | 1.08 | Inv. |
| 1-7 | S-6 | 0.45 | A | 1.01 | Comp. |
| 1-8 | S-7 | 0.45 | A | 0.98 | Comp. |
| 1-9 | S-4 | 0.12 | A | 1.02 | Comp. |
| 1-10 | S-4 | 0.20 | A | 1.10 | Inv. |
| 1-11 | S-4 | 0.30 | A | 1.14 | Inv. |
| 1-12 | S-4 | 0.75 | B | 1.18 | Inv. |
| 1-13 | S-4 | 2.25 | C | 1.18 | Inv. |
| 1-14 | S-4 | 3.00 | D | 1.18 | Comp. |

It is clear from the results described in table 2 that recording sheets of this invention, containing 0.15-2.5 g of a surfactant provided with a dynamic surface tension of a 0.3% aqueous solution, which is measured by a maximum bubble pressure method, of not more than 60 mN/m at 20 m·sec under a condition of a liquid temperature of 35° C., exhibit an excellent ink absorbability as well as an excellent dot enlargement ratio, compared to the comparative examples.

### Example 2

<Preparation of Recording Sheet 2-1>

Recording sheet 2-1 was prepared in a similar manner to the preparation of recording sheet 1-1 of example 1, except that coating and drying conditions of an ink absorptive layer were changed as described below.

[Coating and Drying Conditions]

The ink absorptive layer coating solution was coated on a support by use of a curtain coater at a wet thickness of 150 μm and a coating speed of 100 m/min, immediately followed by being cooled in a cooling zone kept at 5° C., and then dried stepwise by each drying wind respectively in three drying zones of different temperature and humidity: the first drying zone (25° C., a relative humidity of 15%), the second drying zone (45° C., a relative humidity of 25%) and the third drying zone (50° C., a relative humidity of 25%). Then the coated product was rehumidified under an environment of 20-25° C. and a relative humidity of 40-60% for 2 minutes followed by being wound up as a roll form, resulting in preparation of recording sheet 2-1.

<Preparation of Recording Sheets 2-2-2-13>

Recording sheets 2-2-2-13 were prepared in a similar manner to the preparation of recording sheet 2-1 described above, except that each surfactant described in table 3 was added so as to make an addition amount described in table 3.

<Recording Sheets 2-14-2-17>

Each silica dispersion P-1 was prepared and utilized for an ink absorptive coating solution in a similar manner to the preparation of recording sheet 2-1 described above at the time of preparation of silica dispersion P-1, except that the addition amount of an aqueous solution, in which 2.6 g of boric acid and 1.8 g of borax were dissolved, was changed as follows and the pH of silica dispersion P-1 was adjusted to 4.5 with a phosphoric acid buffer solution. And recording sheet 2-14-2-17 were prepared in a similar manner to the preparation of recording sheet 2-1, except that surfactant S-4 was added into an ink absorptive layer coating solution at a concentration of 0.3% as a concentration in an ink absorptive layer coating solution. Herein, the mean particle diameter of silica particles contained in obtained silica dispersion P-1 was measured by a laser scattering method (Zetasizer 1000 manufactured by Malvan Corp.) to be 36-38 nm.
Recording sheet 2-14: 50 ml
Recording sheet 2-15: 30 ml
Recording sheet 2-16: 15 ml
Recording sheet 2-17: 65 ml
   <Viscosity Measurement of Each Ink Absorptive Layer Coating Solution>

With respect to each ink absorptive layer coating solution utilized in the preparation of above-described recording sheets-2-1-2-17, viscosities at 40° C. and at 15° C. were measured by use of B type viscometer manufactured by Toki Sangyo Co., Ltd. and the obtained results are shown in table 3.

<Evaluation of Each Recording Sheet>

With respect to each ink recording sheet described above, evaluations of ink absorbability, glossiness and a dot enlargement ratio, as well as an evaluation of cracking resistance according to the following method were performed, and the obtained results are shown in table 3.

[Evaluation of Cracking Resistance]

With respect to 10×10 cm² of the ink absorptive layer side surface of each recording sheet, the number of generated cracks of not less than 5 μm in size was counted by use of a loupe to evaluate cracking resistance according to the following criteria. Herein, the allowable limit level with respect to coated layer quality is C, and out of the allowable range is D.

TABLE 3

| | Ink Absorptive Layer | | | | | | | | | | |
|---|---|---|---|---|---|---|---|---|---|---|---|
| | Surfactant | | | | | | Result | | | | |
| | | Addition Amount | | | Viscosity | | | | | Dot | |
| Recording | | In coating | | A at 40° C. | B at 15° C. | | Ink | Glossiness | Cracking | Enlargement | |
| sheet No. | | solution (%) | (g/m²) | (mPa · s) | (mPa · s) | B/A | Absorbability | (%) | Resistance | Ratio | Remark |
| 2-1 | — | — | — | 62 | 24000 | 387 | A | 26.4 | B | 1.01 | Comp. |
| 2-2 | S-1 | 0.30 | 0.45 | 58 | 15500 | 267 | A | 42.9 | C | 1.19 | Inv. |
| 2-3 | S-2 | 0.30 | 0.45 | 56 | 12000 | 214 | A | 43.0 | C | 1.17 | Inv. |
| 2-4 | S-3 | 0.30 | 0.45 | 54 | 22000 | 407 | A | 44.2 | A | 1.18 | Inv. |
| 2-5 | S-4 | 0.30 | 0.45 | 53 | 23000 | 434 | A | 43.8 | A | 1.16 | Inv. |
| 2-6 | S-5 | 0.30 | 0.45 | 59 | 18000 | 305 | A | 38.9 | B | 1.08 | Inv. |
| 2-7 | S-6 | 0.30 | 0.45 | 55 | 24000 | 436 | A | 31.0 | B | 1.02 | Comp. |
| 2-8 | S-7 | 0.30 | 0.45 | 57 | 11000 | 193 | A | 29.5 | C | 0.98 | Comp. |
| 2-9 | S-4 | 0.08 | 0.12 | 55 | 23000 | 418 | A | 32.0 | B | 1.01 | Comp. |
| 2-10 | S-4 | 0.20 | 0.30 | 53 | 23000 | 434 | A | 41.5 | A | 1.15 | Inv. |
| 2-11 | S-4 | 0.50 | 0.75 | 51 | 22500 | 441 | B | 44.3 | A | 1.17 | Inv. |
| 2-12 | S-4 | 1.50 | 2.25 | 48 | 19800 | 413 | C | 44.5 | A | 1.18 | Inv. |
| 2-13 | S-4 | 2.00 | 3.00 | 49 | 18000 | 367 | D | 44.3 | A | 1.18 | Comp. |
| 2-14 | S-4 | 0.30 | 0.45 | 55 | 2800 | 51 | B | 42.9 | B | 1.17 | Inv. |
| 2-15 | S-4 | 0.30 | 0.45 | 56 | 1900 | 34 | B | 42.2 | C | 1.16 | Inv. |
| 2-16 | S-4 | 0.30 | 0.45 | 56 | 400 | 7 | C | 41.9 | C | 1.15 | Inv. |
| 2-17 | S-4 | 0.30 | 0.45 | 55 | 5940 | 108 | A | 43.4 | A | 1.16 | Inv. |

A: Cracks of not less than 5 μm in size are not generated at all.
B: The number of generated cracks of not less than 5 μm in size is 1-3.
C: The number of generated cracks of not less than 5 μm in size is 4-9.
D: The number of generated cracks of not less than 5 μm in size is at least 10.

It is clear from the results described in table 3 that recording sheets of this invention which contain 0.15-2.5 g/m² of a surfactant provided with a surface tension of a 0.3% aqueous solution of not more than 60 mN/m at 20 m·sec under a condition of a liquid temperature of 35° C., exhibit excellent ink absorbability and a dot enlargement ratio as well as excellent cracking resistance, compared to comparative examples. Among them, particularly, a recording sheet prepared by utilizing an ink absorptive layer coating solution, which is provided with a viscosity at 40° C. is 10-300 mPa·s and a viscosity at 15° C. is not less than 40 times of the viscosity at 40° C., more efficiently exhibits the effect.

### Example 3

Ink liquids 2-5 were prepared in a similar manner to the preparation of ink liquid 1 in example 1, except that the surfactant of ink liquid 1 was replaced by each surfactant described in table 4. Images 3-1-3-5 were printed with combinations of each of these ink liquids and recording sheets 2-3,2-5, 2-7 and 2-18(which is explained below) described in table 4, and a dot enlargement ratio and ink absorbability were evaluated in a similar manner to the method described in example 1. Herein, the ejection condition of each ink was adjusted to make the liquid quantity of each ink liquid of 7 pl by adjusting the head drive energy.

<Preparation of Recording Sheets 2-18>

Recording sheets 2-18 was prepared in a similar manner to the preparation of recording sheet 2-3 described above, except that the surfactant was changed into S-9 described in table 1.

Further, with respect to a 0.3% aqueous solution of each surfactant utilized in preparation of a recording sheet or an ink liquid, which were employed for each image formation, a dynamic surface tension by a maximum bubble pressure method at 20 m·sec under a condition of a liquid temperature of 35° C. was measured, to obtain a dynamic surface tension of a surfactant utilized in preparation of a recording sheet as Tp, and a dynamic surface tension of a surfactant utilized in preparation of an ink liquid as Ti, and further the ratio Ti/Tp was calculated; the results are shown in table 4.

TABLE 4

| | Recording Sheet | | | Ink | | | | Dot | |
|---|---|---|---|---|---|---|---|---|---|
| Example | Recording | | | Ink | | | | Enlargement | Ink |
| No. | Sheet No. | Surfactant | T(p) | Liquid No. | Surfactant | T(i) | T(i)/T(p) | Ratio | Absorbability |
| 3-1 | 2-7 | S-6 | 62.7 | 2 | S-7 | 69.9 | 1.11 | 1.01 | A |
| 3-2 | 2-5 | S-4 | 53.4 | 3 | S-4 | 53.4 | 1.00 | 1.17 | A |
| 3-3 | 2-5 | S-4 | 53.4 | 4 | S-2 | 44.9 | 0.84 | 1.12 | A |
| 3-4 | 2-5 | S-4 | 53.4 | 5 | S-1 | 38.5 | 0.72 | 1.06 | A |
| 3-5 | 2-5 | S-4 | 53.4 | 2 | S-7 | 69.9 | 1.31 | 1.21 | A |
| 3-6 | 2-3 | S-2 | 44.9 | 5 | S-1 | 38.5 | 0.86 | 1.25 | A |
| 3-7 | 2-18 | S-9 | 31.0 | 5 | S-1 | 38.5 | 1.24 | 1.28 | A |

It is clear from the results described in table 4 that an inkjet recording method of this invention, which was performed under a condition of Ti/Tp>0.8 and Tp of a surfactant utilized in a recording sheet being not more than 60 mN/m, exhibits a high dot enlargement ratio and maintains excellent ink absorbability compared to comparative examples.

### Example 4

An ink absorptive layer coating solution was prepared in a similar manner to the method described in examples 1-3, except that polyvinyl alcohol (product name: PVA 235, manufactured by Kuraray Corp.) as a hydrophilic binder utilized in preparation of each recording sheet was replaced by a 8% aqueous solution of ultraviolet polymerizing polyvinyl alcohol (PVA-H) synthesized by the following method, and was coated in a similar manner to recording sheets 1-1-1-14 and recording sheets 2-1-2-16. Next, coated each ink absorptive layer was irradiated with ultraviolet rays immediately after having been coated by use of a metal halide lamp equipped with a filter to cut wavelengths of not longer than 300 nm (365 filter manufactured by Iwasaki Electric Co., Ltd.) under a condition of an illuminance of 100 mW/cm² and an energy quantity of 30 mJ/cm², and each recording sheet was prepared employing a photo-cross-linkable polymer as a binder.

(Preparation of Ultravilolet Polymerizable Polyvinyl Alcohol (PVA-H))

According to the method described in JP-A No. 2000-181062, after polyvinyl alcohol having a polymerization degree of 3000 and a saponification degree of 88% was reacted with p-(3-metharyloxy-2-hydroxypropyloxy)benzaldehyde, 1.8 weight % against polyvinyl alcohol of a photo-polymerization initiator (Kayacure QTX manufactured by Nippon Kayaku Co., Ltd.) was added, resulting in preparation of ultraviolet polymerizable polyvinyl alcohol having a cross-linking group modification rate of 1 mol % and a solid concentration of 8 weight %.

With respect to recording sheets utilizing each cross-linkable type polymers prepared in the above manner, evaluation of each characteristic similar to the method described in examples 1-3 was performed, resulting in confirming, similarly to the results described in example 1-3, that recording sheets comprising a constitution defined by this invention or inkjet recording methods of this invention are excellent in ink absorbability, a dot enlargement ratio and glossiness as well as in cracking resistance compared to comparative examples.

Further, among above-described evaluations, it has been also confirmed that a recording sheet prepared by utilizing an ink absorptive layer coating solution, satisfying the condition in which the modulus of elasticity measured by a rigid pendulum of the ink absorptive layer coating solution to form an ink absorptive layer is increased by not less than 1.5 times with ionization radiation irradiation, is provided with more excellent characteristics.

1. An inkjet recording sheet comprising a support and provided thereon, a porous ink absorptive layer containing inorganic micro-particles and a hydrophilic binder,
wherein the ink absorptive layer contains 0.15-2.5 g/m² of a surfactant having a dynamic surface tension of a 0.3% aqueous solution, which is measured by a maximum bubble pressure method, of not more than 60 mN/m at 20 m·sec under a condition of a liquid temperature of 35° C.

2. The inkjet recording sheet of claim 1,
wherein the inorganic micro-particles are silica by a gas phase method having a mean particle diameter of not more than 100 nm.

3. The inkjet recording sheet of claim 1, wherein the surfactant is at least one of polyoxyethylene alkyl ether, and alkyltrimethylammonium chloride, provided with an alkyl group having a carbon number of 7 to 12, acetylene glycols, block polymer of ethyleneoxide and propyleneoxide, and sorbitan derivatives.

4. A manufacturing method of a inkjet recording sheet in which an porous ink absorptive layer comprising the steps of:
coating for coating a solution containing at least in organic micro-particles and a hydrophilic binder onto a support to form the porous ink absorptive layer;
drying for drying the coated solution to form the ink absorptive layer,
wherein the ink absorptive layer coating solution contains 0.15-2.5 g/m² of a surfactant having a dynamic surface tension of a 0.3% aqueous solution, which is measured by a maximum bubble pressure method, of not more than 60 mN/m at 20 m·sec under a condition of a liquid temperature of 35° C.

5. The manufacturing method of claim 4,
wherein viscosity A at 40° C. of the porous ink absorptive layer coating solution is 10 to 300 mPa·s and viscosity B at 15° C. is not less than 40 times of the viscosity A.

6. The manufacturing method of claim 4,
wherein the modulus of elasticity of the porous ink absorptive layer coating solution measured by a ridged pendulum is not less than 1.5 times with ionized radiation irradiation.

7. An inkjet recording method comprising the step of jetting inkjet ink onto a inkjet recording sheet,
wherein the inkjet recording sheet comprises a support and provided thereon, a porous ink absorptive layer containing a surfactant having a dynamic surface tension of a 0.3% aqueous solution, which is measured by a maximum bubble pressure method, of Tp (mN/m) at 20 m·sec under a condition of a liquid temperature of 35° C.,
wherein the inkjet ink comprises a surfactant having a dynamic surface tension of a 0.3% aqueous solution, which is measured by a maximum bubble pressure method, of Ti (mN/m) at 20 m·sec under a condition of a liquid temperature of 35° C., and
wherein Ti/Tp is not less than 0.8 and Tp is not more than 60 mN/m.

8. The inkjet recording method of claim 7,
wherein the surfactant in the porous ink absorptive layer is block polymer of ethyleneoxide and propyleneoxide, and
wherein the surfactant in the inkjet ink is ethyleneoxide adduct of acetylene glycol.

9. The inkjet recording method of claim 8,
wherein the surfactant in both the porous ink absorptive layer and the inkjet ink is an ethyleneoxide adduct of acetylene glycol, and
wherein a number of moles of ethyleneoxide to one mole of acetylene glycol in the inkjet ink is not less than a number of moles of ethyleneoxide to one mole of acetylene glycol in the ink absorptive layer.

10. The inkjet recording method of claim 7,
wherein the inkjet recording sheet comprises the porous ink absorptive layer containing inorganic micro-particles and a hydrophilic binder,
wherein the ink absorptive layer contains 0.15-2.5 g/m² of a surfactant having the Tp(mN/m) of not more than 60.

11. The inkjet recording method of claim 10,
wherein the inorganic micro-particles are silica by a gas phase method having a mean particle diameter of not more than 100 nm.
